(19) United States
(12) Patent Application Publication
(10) Pub. No.: US 2019/0004254 A1
(43) Pub. Date: Jan. 3, 2019

(54) OPTICAL CONNECTOR

(71) Applicant: OLYMPUS CORPORATION, Tokyo (JP)

(72) Inventors: Masahiro YOSHINO, Tokyo (JP); Seiki TORIYAMA, Tokyo (JP); Hiroyoshi YAJIMA, Sagamihara-shi (JP); Shinichi MATSUMOTO, Tokyo (JP); Yoshiyuki HIYAMA, Tokyo (JP)

(73) Assignee: OLYMPUS CORPORATION, Tokyo (JP)

(21) Appl. No.: 16/101,726

(22) Filed: Aug. 13, 2018

Related U.S. Application Data
(63) Continuation of application No. PCT/JP2017/009744, filed on Mar. 10, 2017.

(30) Foreign Application Priority Data
Mar. 11, 2016 (JP) 2016-048333

(51) Int. Cl. G02B 6/38

(52) U.S. Cl. CPC G02B 6/3871; G02B 6/3826; G02B 6/3843; G02B 6/3821; G02B 6/3877; G02B 6/3897; G02B 6/3825

(57) ABSTRACT

An optical connector includes a plug frame including a ferrule insertion portion. An eight-sided regular polygonal attachment hole, into which a four-sided regular polygonal flange portion of a flange is fitted, is formed in the ferrule insertion portion so that vicinities of outer corner portions of a four-sided regular polygon of the flange portion come into contact with inner corner portions of the eight-sided regular polygonal attachment hole, thereby preventing rotation of the flange centered on an axis direction of the flange. A ferrule is inserted into the plug frame while a rotation position determined by the flange portion and the attachment hole is adjusted relative to a direction of eccentricity of an optical fiber in a ferrule cylindrical body, and the ferrule is fitted in and held by the plug frame.

### CROSS REFERENCE TO RELATED APPLICATION

This application is a continuation application of PCT/JP2017/009744 filed on Mar. 10, 2017 and claims benefit of Japanese Application No. 2016-048333 filed in Japan on Mar. 11, 2016, the entire contents of which are incorporated herein by this reference.

### BACKGROUND OF INVENTION

### 1. Field of the Invention

The present invention relates to an optical connector configured to connect optical paths transmitting light.

### 2. Description of the Related Art

In general, in optical connectors that connect optical paths transmitting light through optical fiber, optical fibers, each of which is held by a ferrule, need to be stably aligned with each other with high accuracy at respective connection portions of respective connectors in order to reduce connection loss and also reduce reflected return light.

For example, according to a configuration of a connector disclosed in Japanese Patent Publication No. 4142891, optical fibers are connected to each other by fitting a ferrule having a square-shaped flange part into a square-shaped hole formed in a frame of the connector, or by fitting a ferrule having a hexagon-shaped flange part into a hexagon-shaped hole formed in the frame.

### SUMMARY OF THE INVENTION

An optical connector according to an embodiment of the present invention includes: a ferrule configured to hold an optical transmitter that transmits light at a central axis of the ferrule, and including a flange portion formed as an n-sided regular polygonal columnar shape; and a housing having a 2n-sided regular polygonal attachment hole which configured to attach the flange portion of the ferrule to the housing, wherein the attachment hole comprising: a first rotation restriction portion configured to restrict rotation of the flange portion against a direction of the central axis of the ferrule by contact n-corners of the 2n-sided regular polygon of the attachment hole with an outer corner of the n-sided regular polygon of the flange portion, when the ferrule is attached to the housing at a first rotation angle on the direction of the central axis; and a second rotation restriction portion configured to restrict the rotation of the ferrule against the direction of the central axis of the ferrule by contact an n-corners of the attachment hole differed from the n-corners of the 2n-sided regular polygon of the attachment hole with the outer corner of the n-sided regular polygon of the flange portion, when the ferrule is attached to the housing at a second rotation angle that is different from the first rotation angle.

### BRIEF DESCRIPTION OF THE DRAWINGS

FIG. 1 is an exploded perspective view of an optical connector;

FIG. 2 is an exploded plan view of the optical connector;

FIG. 3 is a sectional view of the optical connector assembled;

FIG. 4 is a perspective view of a ferrule;

FIG. 5 is a sectional view of the ferrule;

FIG. 6 is a cross-sectional view of a main portion of the optical connector;

FIG. 7 is a cross-sectional view showing a state where the ferrule is fitted in a plug frame;

FIG. 8 is an explanatory diagram showing rotational displacement between the plug frame and the ferrule;

FIG. 9 is an explanatory diagram showing a first modification of a portion where the ferrule is fitted into the plug frame;

FIG. 10 is an explanatory diagram showing a case in which outer corner portions of a flange portion are not pointed;

FIG. 11 is an explanatory diagram showing an example in which the outer corner portions of the flange portion are chamfered;

FIG. 12 is an explanatory diagram showing a second modification of the portion where the ferrule is fitted into the plug frame;

FIG. 13 is an external view showing an endoscope system to which the optical connector of the present invention is applied;

FIG. 14 is a block diagram showing a functional configuration of the endoscope system; and

FIG. 15 is a schematic diagram showing a state where a connector of the endoscope system and a connector of a light source apparatus are connected to each other.

### DETAILED DESCRIPTION OF THE PREFERRED EMBODIMENT

Hereinafter, an embodiment of the present invention will be described with reference to drawings. An optical connector of the present invention is configured to connect optical paths when light as a signal in optical communication or light such as illuminating light toward or reflected light from an object is transmitted through optical fiber. For example, the optical connector of the present invention can be applied to connectors that connect optical paths by coupling optical fibers face-to-face in a contact or non-contact manner.

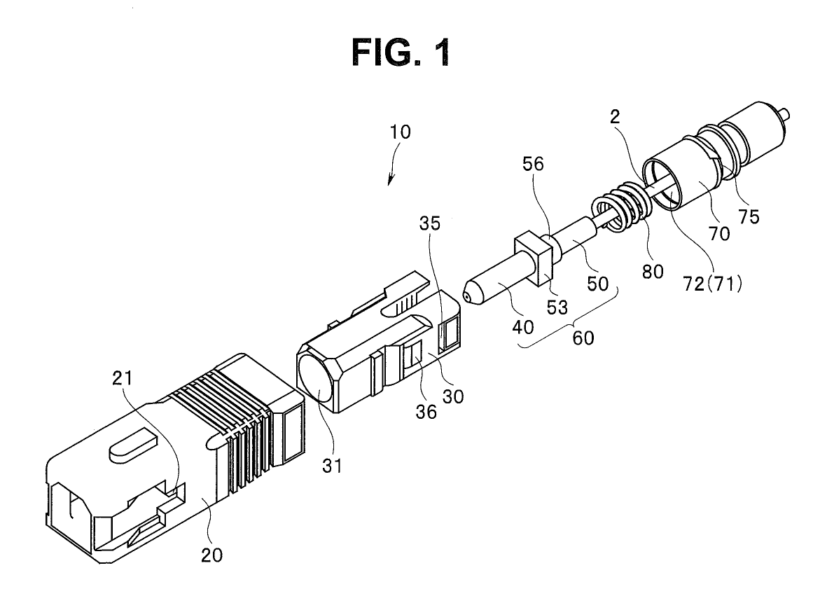

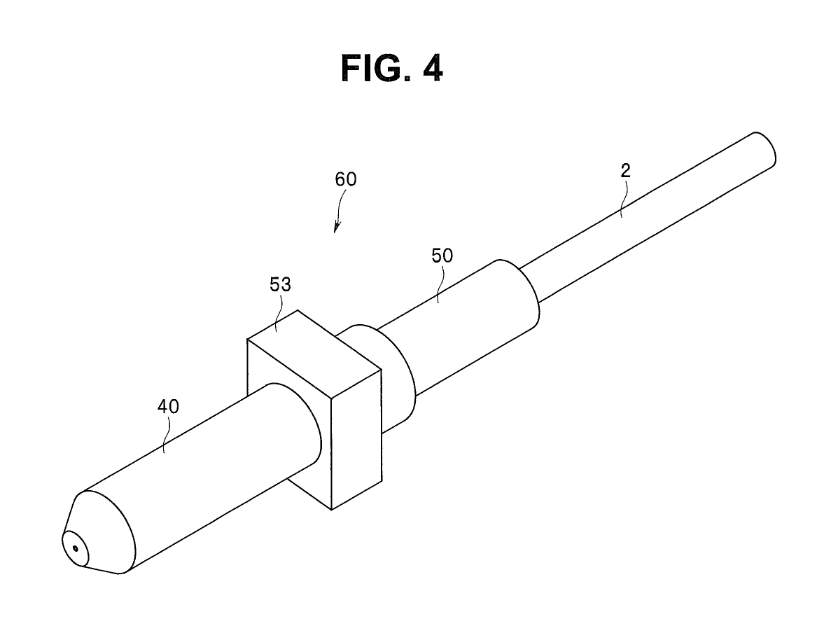

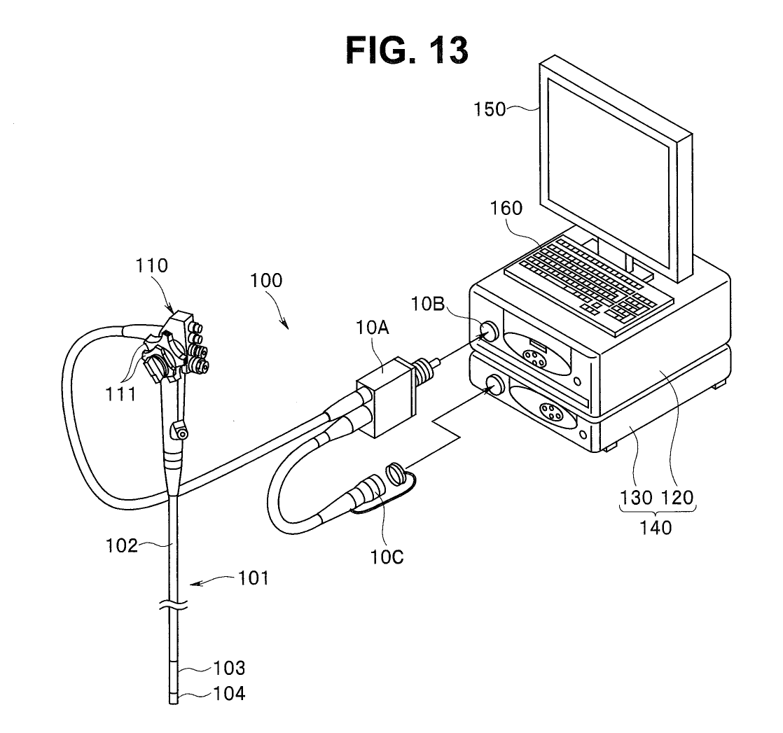

Hereinafter, as shown in FIGS. 1 to 12, a plug connector configured to be fitted into an SC optical connector adaptor (not shown) as an optical connector which is used for network cables. An optical connector included in an endoscope for medical use is illustrated in FIG. 13.

As shown in FIGS. 1 to 4, an optical connector 10 includes a plug housing body 20 configured to form a connector case, a plug frame 30 configured to be attached into the plug housing body 20, a ferrule 60 configured to hold, at a central axis thereof, an optical fiber which is an optical transmitter transmitting light, and also configured to be inserted into the plug frame 30 from a rear of the plug frame 30, a stop ring 70, a distal end portion of which is configured to engage with a rear end portion of the plug frame 30, and an energizing spring 80 configured to energize the ferrule 60 toward a distal end side of the ferrule 60 in an axis direction of the ferrule 60 by being held between the ferrule 60 and the stop ring 70.

Note that in the present embodiment, the plug housing body 20 and the plug frame 30 are separately configured as housing body that become the connector case, and the plug frame 30 in which the ferrule 60 is inserted is configured to be fitted into the plug housing body 20. However, the plug housing body 20 and the plug frame 30 may also be configured as a single-piece housing body.

The ferrule 60 includes a ferrule cylindrical body 40 formed in an approximate cylindrical shape, and a flange 50 fitted on an end portion of the ferrule cylindrical body 40. The ferrule cylindrical body 40 is formed of, for example, a ceramic material such as zirconia, a plastic material, a glass material such as crystallized glass, borosilicate glass, or quartz, or a metal material such as stainless steel, nickel, or nickel alloy.

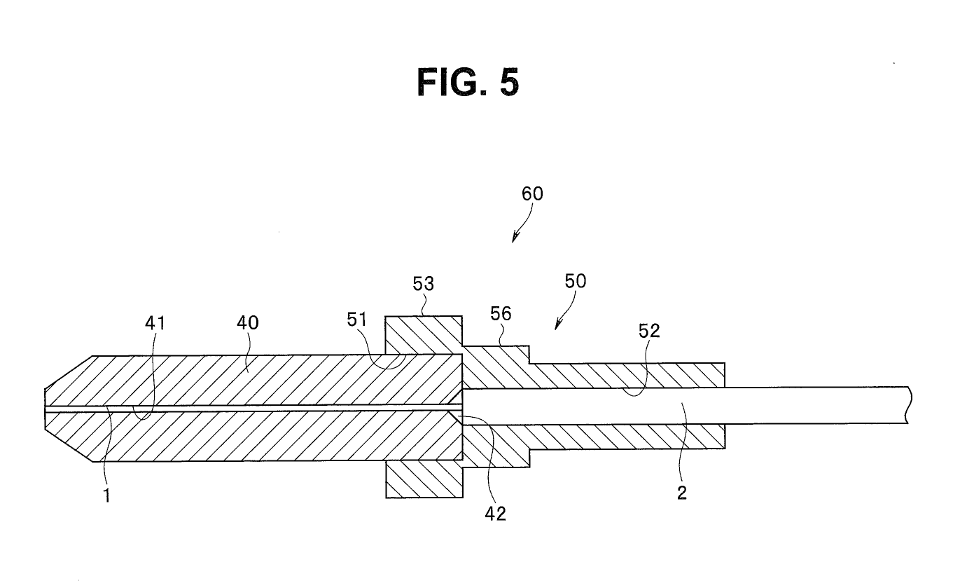

As shown in FIG. 5, an optical fiber insertion hole 41 is formed within the ferrule cylindrical body 40, penetrating the ferrule cylindrical body 40 in a central axis direction of the ferrule cylindrical body 40, to hold an optical fiber 1 by allowing the optical fiber 1 to be inserted into the optical fiber insertion hole 41. A taper portion 42, an inside diameter of which is gradually enlarged toward an opening side, is formed at a rear end portion of the optical fiber insertion hole 41. The taper portion 42 is to prevent a distal end of the optical fiber 1 from chipping or breaking due to contact with an end face of the ferrule cylindrical body 40 when the optical fiber 1 is inserted into the optical fiber insertion hole 41.

A distal end of the ferrule cylindrical body 40 as described above is formed in a flat surface that tilts relative to a plane orthogonal to an axis of the ferrule cylindrical body 40, or a convex shape such as a convex sphere. When the optical connector 10 is connected face-to-face to another optical connector 10 via the optical connector adaptor, the respective distal ends of the respective ferrule cylindrical bodies 40 are connected in a split sleeve so that connection points of the respective optical fibers 1 in the ferrule cylindrical bodies 40 are aligned with each other.

The flange 50 has an attachment hole 51 into which the end portion of the ferrule cylindrical body 40 is fitted, and a coated-optical-fiber insertion hole 52 configured to hold a coated optical fiber 2, which is the optical fiber 1 with a coating or coatings applied to an outer periphery of the optical fiber 1, by allowing the coated optical fiber 2 to be inserted into the coated-optical-fiber insertion hole 52. The flange 50 of the ferrule 60 also includes a columnar flange portion 53 formed in a polygonal outer shape with corner portions, each of which protrudes by a predetermined amount outward from an outer periphery of the flange 50 on a side where the attachment hole 51 opens. The flange portion 53 is formed, for example, such as to have a cross section in a four-sided regular polygonal shape.

A spring guide portion 56, which has a smaller outside diameter than an outside diameter of the flange portion 53, is provided on a rear portion side of the flange 50. The energizing spring 80 such as a compression spring is fitted on an outer periphery of the spring guide portion 56 and supported between the stop ring 70 and the flange portion 53.

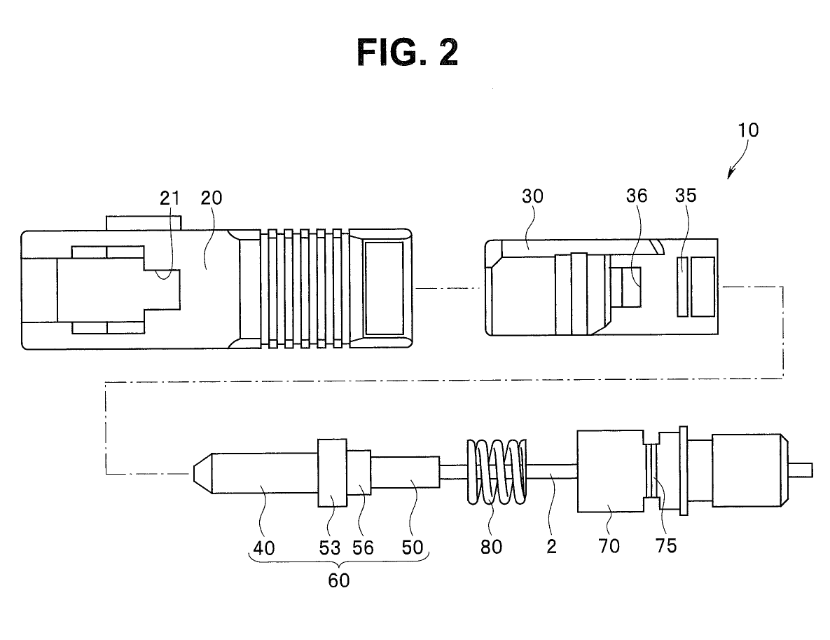

On the other hand, the plug frame 30 has an outer shape, a cross section of which is an approximate rectangle, and is formed of, for example, plastic. In the plug frame 30, two locking holes 35 are formed, which communicate with a ferrule insertion portion 31, which will be described later, and open on an outer periphery of the plug frame 30, as shown in FIGS. 1 and 2. The locking holes 35 are configured to lock locked portions 75 provided at a distal end of the stop ring 70.

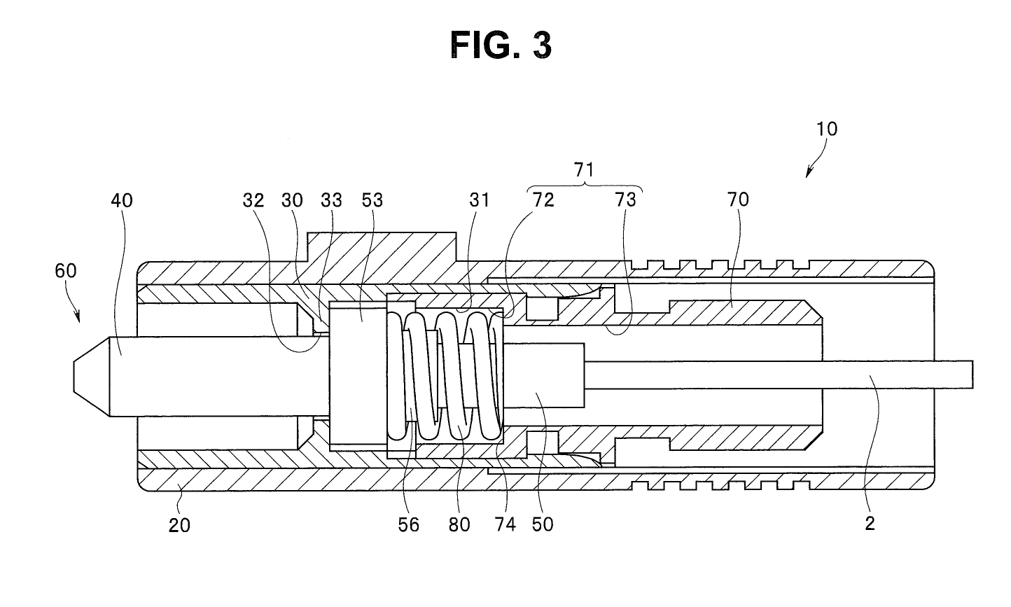

The stop ring 70 is formed of, for example, metal such as stainless steel or brass, or plastic, and is formed in a cylindrical shape having a penetrating hole 71, which penetrates the stop ring 70 in an axis direction of the stop ring 70 and into which the spring guide portion 56 of the flange 50 can be inserted, as shown in FIG. 3. The penetrating hole 71 includes a larger diameter portion 72, into which the energizing spring 80 can be inserted on a distal end portion side, and a smaller diameter portion 73, into which the spring guide portion 56 of the flange 50 can be inserted on a rear end portion side. The penetrating hole 71 is configured to have one of ends of the energizing spring 80 butt against a step portion 74 created by a difference in inside diameter between the larger diameter portion 72 and the smaller diameter portion 73.

Note that the other end of the energizing spring 80 butts against a rear end-side end face of the flange portion 53 so that the flange 50 is energized frontward in an axis direction of the flange 50 against the stop ring 70.

The locked portions 75, which protrude in the locking holes 35 when the stop ring 70 is inserted into the plug frame 30, are provided on a distal end-side outer periphery of the stop ring 70. Each of the locked portions 75 has a tapered shape, in which a protrusion amount becomes smaller toward a distal end. The locked portions 75 are configured to enter the plug frame 30 while pushing and enlarging the rear end portion of the plug frame 30 and to be locked in the locking holes 35.

Further, two engagement convex portions 36 configured to engage with the plug housing body 20 are provided on the outer periphery of the plug frame 30. The engagement convex portions 36 engage with engagement concave portions 21 on the plug housing body 20, whereby the plug frame 30 is held in the plug housing body 20 in such a manner that the plug frame 30 can move within a predetermined range in an axis direction of the plug frame 30.

When the optical connector 10 as described above is connected face-to-face to another optical connector 10 via an optical connector adapter (not shown), the ferrule 60 is configured to be held in a state of having been moved toward the stop ring 70 so that the ferrule 60 abuts against a counterpart ferrule 60 under a predetermined pressure.

Here, a description will be given of a positioning structure in the plug frame 30 in which the ferrule 60 is inserted and held. As shown in FIG. 3, the ferrule insertion portion 31 penetrating the plug frame 30 in a longitudinal direction of the plug frame 30 is provided in the plug frame 30. A wall portion 33, against which an end face of the flange portion 53 of the flange 50 butts, is provided approximately in the middle of the ferrule insertion portion 31, and a protrusion hole 32 is formed in the wall portion 33. The protrusion hole 32 has an inside diameter that is slightly larger than an outside diameter of the ferrule cylindrical body 40, and only the ferrule cylindrical body 40 can protrude from the protrusion hole 32.

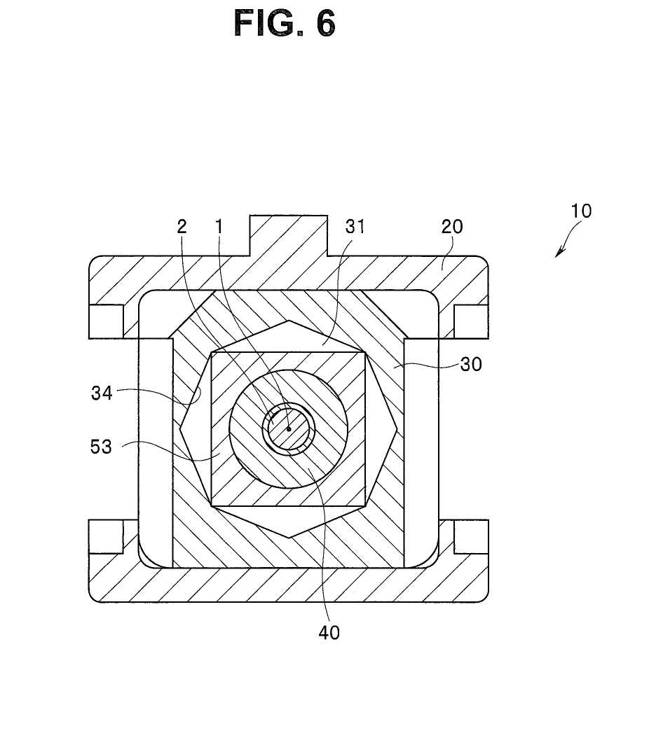

A polygonal attachment hole 34, into which the polygonal flange portion 53 of the flange 50 is attached, is formed in a rear of the wall portion 33 (a side from which the ferrule 60 is inserted) of the ferrule insertion portion 31, as shown in FIG. 6. The attachment hole 34 forms a rotation restriction portion that comes into contact with an outer periphery of the flange portion 53 of the ferrule 60 and thereby restricts rotation of the flange 50 on the central axis direction. Respective polygonal shapes of the flange 50 and the attachment hole 34 are set taking rotational symmetry or the like into consideration. If the flange portion 53 of the flange 50 of the ferrule 60 has an n-sided (n; a natural number excluding 0) regular polygonal cross section, the attachment hole 34 of the housing body is formed to have a 2n-sided regular polygonal cross section. FIG. 6 shows an example in which the attachment hole 34 is formed as an eight-sided regular polygonal hole, while the flange portion 53 of the ferrule 60 is a four-sided regular polygon. Vicinities of outer corner portions of the four-sided regular polygon of the flange portion 53 come into contact with inner corner portions of the eight-sided regular polygonal attachment hole 34, whereby rotation of the flange 50 centered on the axis direction is prevented.

To make the plug frame 30 as described above hold the ferrule 60, the ferrule 60 is inserted into the plug frame 30 while a rotation position determined by the polygonal flange portion 53 and the polygonal attachment hole 34 is adjusted relative to a direction of eccentricity of the optical fiber 1 in the ferrule cylindrical body 40.

Next, the energizing spring 80 and the stop ring 70, in which the coated optical fiber 2 is inserted beforehand, are sequentially inserted into the plug frame 30, whereby the locked portions 75 on the stop ring 70 are locked in the locking holes 35 on the plug frame 30, and the stop ring 70 is fixed to the plug frame 30. As a result, a face on a distal end side of the flange portion 53 of the ferrule 60 abuts against the wall portion 33 of the plug frame 30, and the ferrule 60 is energized frontward in the central axis direction and held, protruding from the protrusion hole 32 of the wall portion 33 by a predetermined amount, in a state where a movement of the ferrule 60 toward the distal end side is restricted.

Note that the direction of eccentricity and an eccentric amount of the optical fiber 1 can be obtained, for example, by picking up, using a camera or the like, an image of patterns of light outgoing from the optical fiber 1 when light is inputted to the optical fiber 1, and subjecting the image to image processing. Accordingly, when the optical connector 10 is connected face-to-face to another optical connector 10 via the optical connector adapter, connection points of the respective optical fibers 1 in the respective ferrule cylindrical bodies 40 can be aligned by adjusting the rotation position determined by the polygonal flange portion 53 and the polygonal attachment hole 34 according to the direction of eccentricity and the eccentric amount of each optical fiber 1.

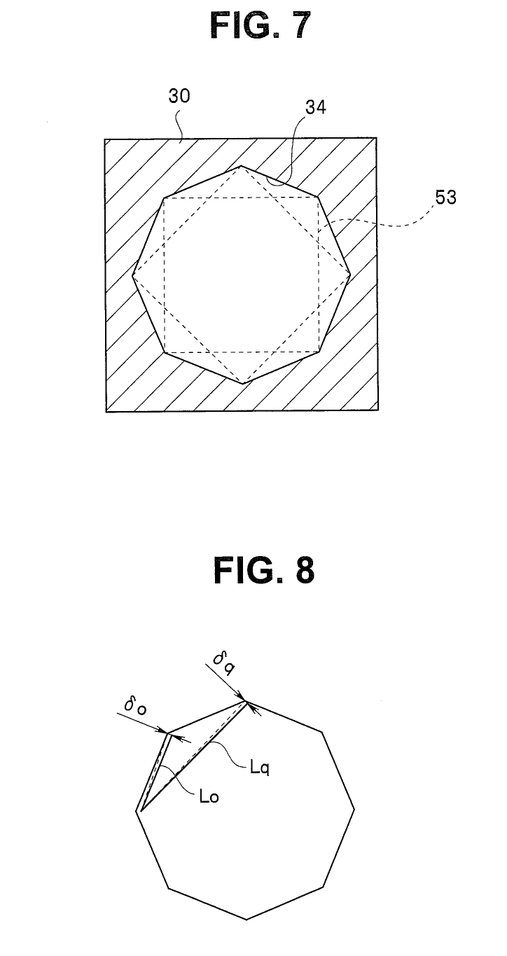

In this case, the flange portion 53 on the ferrule 60 side can be fitted into the attachment hole 34 on the plug frame 30 side while adjusting the rotation position into any one of eight directions each equally at a 45-degree pitch, as shown in FIG. 7. In addition, after fitting, a rotation angle displacement amount can be reduced.

That is, the attachment hole 34 is configured to include a first rotation restriction portion, which, when the flange 50 is fitted into the attachment hole 34 at a first rotation angle centered on the axis direction, restricts rotation of the flange 50 by coming into contact with the outer periphery of the flange portion 53, and include a second rotation restriction portion, which, when the flange 50 is fitted into the attachment hole 34 at a second rotation angle that is different from the first rotation angle, restricts the rotation of the flange 50 by coming into contact with the contact portions of the outer periphery of the flange portion 53 at the first rotation angle. If the flange portion 53 is an n-sided regular polygon and the attachment hole 34 is a 2n-sided regular polygon, n corners of the attachment hole 34 and the n corners of the flange portion 53 come into contact with each other at the first rotation angle, and the other n corners of the attachment hole 34 and the n corners of the flange portion 53 come into contact with each other at the second rotation angle.

Here, assuming that an outer shape of the flange portion 53 of the ferrule 60 is formed in an eight-sided regular polygon and that the flange portion 53 is fitted into the attachment hole 34 in a similar eight-sided regular polygonal shape, a length Lo of each side of the eight-sided regular polygon of the flange portion 53 is shorter than a length Lq of each side of a four-sided regular polygon (Lo<Lq). Assuming that a gap between the flange portion 53 and the attachment hole 34 is constant, the length of each side controls the rotation angle displacement amount, and a rotation angle displacement amount δo when the flange portion 53 is an eight-sided regular polygon with shorter sides is larger than a rotation angle displacement amount δq when the flange portion 53 is a four-sided regular polygon (δo>δq).

In other words, the rotation angle displacement amount can be made smaller as the polygonal flange portion 53 has longer sides. Accordingly, assuming that the outside diameter of the flange portion 53 is constant, as the number of sides of the polygonal flange portion 53 is smaller, the length of each side can be made longer, and consequently the rotation angle displacement amount can be made smaller.

Thus, when the optical fiber 1 is connected face-to-face to another optical fiber 1, the rotation position of the ferrule 60 can be set with more accuracy at a finer rotation angle pitch. In addition, a connection can be accomplished that hardly causes backlash in a rotation direction centered on a connection direction, and thus an optical connector with high connection efficiency can be achieved.

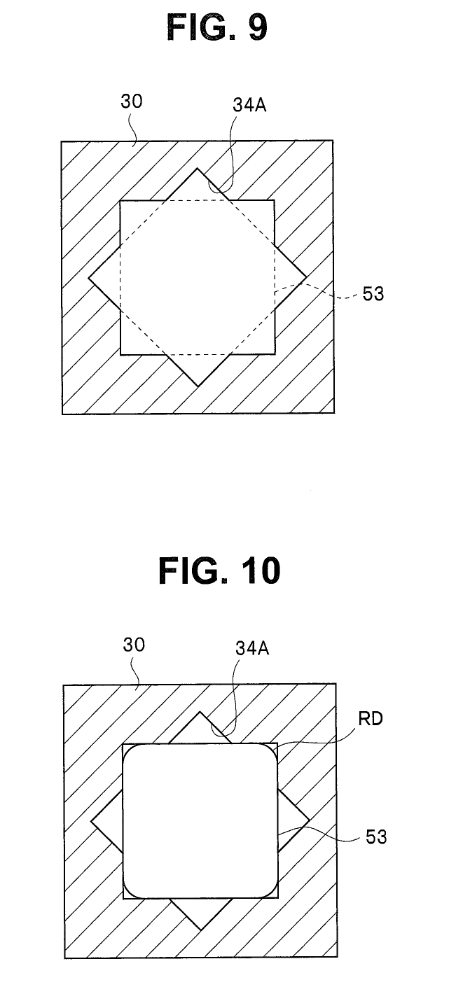

For a portion where the ferrule 60 is fitted into the plug frame 30 by means of the eight-sided regular polygonal attachment hole 34 and the four-sided regular polygonal flange portion 53 as described above, for example, the flange portion 53 may be a three-sided regular polygon or a rectangle in place of the four-sided regular polygon. Further, the attachment hole 34 may be a star polygon to have inner corner portions, shapes of which are approximately equal to shapes of the outer corner portions of the flange portion 53, as shown in FIGS. 9 and 10. A plurality of combinations are conceivable.

A first modification shown in FIG. 9 is an example in which the attachment hole 34 of the plug frame 30 is formed as an eight-pointed star-shaped attachment hole 34A, and the four-sided regular polygonal flange portion 53 of the ferrule 60 is combined with the eight-pointed star-shaped attachment hole 34A. In the first modification, even if the outer corner portions of the four-sided regular polygonal flange portion 53 are not pointed, sides in vicinity of the outer corner portions can be made to butt against an inner wall of the attachment hole 34A, and assembly accuracy can be enhanced when the rotation position is set.

That is, if the flange portion 53 is in a round-cornered polygonal columnar shape, which has unpointed round portions RD formed by rounding the corners of the flange portion 53 as shown in FIG. 10, vicinities of the round portions RD (sides of a polygonal cross section; side faces of the columnar shape) come into contact with the inner wall of the attachment hole 34A, whereby rotation can be prevented. In such a case, chamfered portions CH may also be formed by chamfering the corners of the flange portion 53 beforehand, as shown in FIG. 11. Similarly, vicinities of the chamfered portions CH (sides of a polygonal cross section; side faces of the columnar shape) come into contact with the inner wall of the attachment hole 34A, whereby rotation can be prevented.

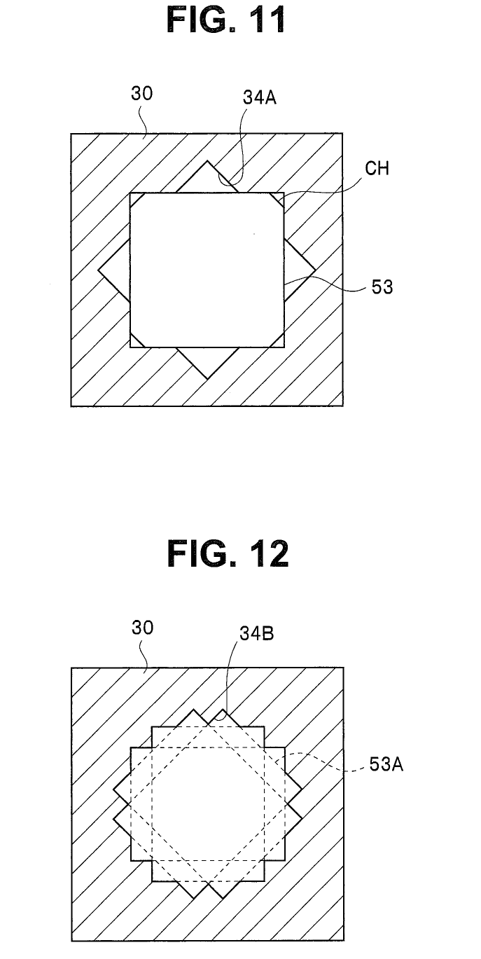

A second modification shown in FIG. 12 is an example in which the attachment hole 34 of the plug frame 30 is formed as a sixteen-pointed star-shaped attachment hole 34B, and the flange portion 53 of the ferrule 60 formed as a rectangular flange portion 53A is combined with the sixteen-pointed star-shaped attachment hole 34B. In the second modification, the flange portion 53A is formed in a rectangular shape, whereby a length of a side of the flange portion 53A can be made longer, and consequently attachment with less rotation displacement can be expected.

The above-described optical connector 10 is not only for optical communications, but also can be applied to equipment in various industrial fields. FIG. 13 shows an endoscope system including an endoscope 100 as medical equipment, wherein the endoscope 100 is connected to a light source apparatus 120 via connectors 10A and 10B, which have a ferrule rotation positioning structure similar to the positioning structure of the optical connector 10, and laser light generated by the light source apparatus 120 is supplied to the endoscope 100.

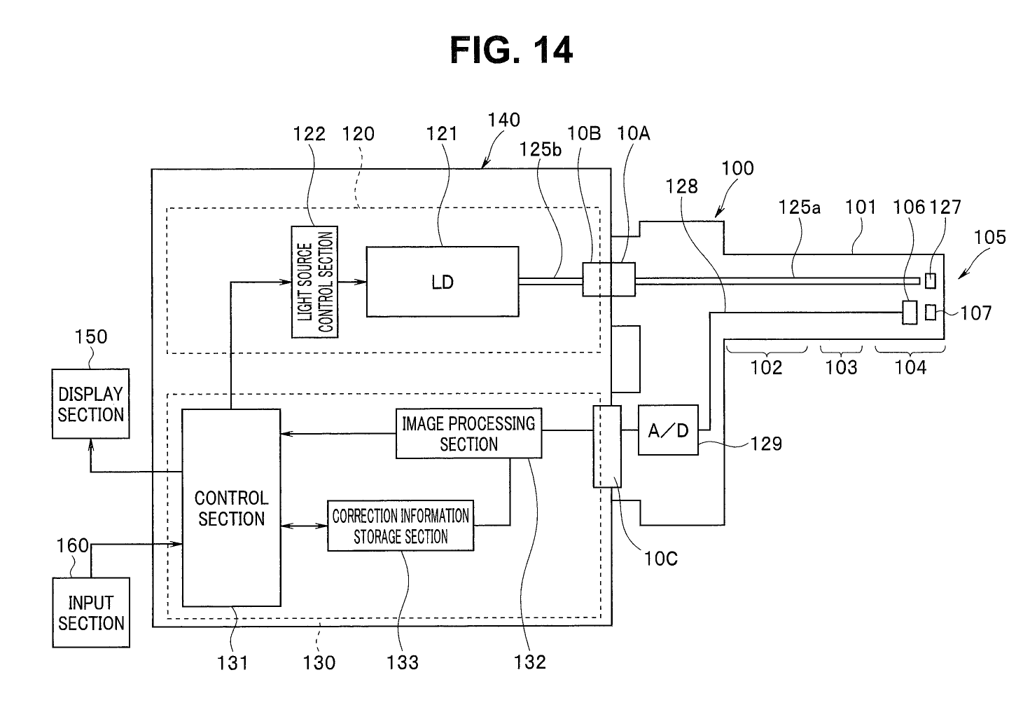

As shown in FIGS. 13 and 14, the endoscope 100 is an electronic endoscope including an illumination optics system that outputs illuminating light from a distal end of an elongated insertion portion 101 configured to be inserted into a subject, and an image pickup optics system that includes an image pickup device 106 configured to pick up an image of an observed region (see FIG. 14). The endoscope 100 includes an operation portion 110 configured to perform an operation for bending the distal end of the insertion portion 101 and an operation for observation, and the connectors 10A and an connector 10C configured to freely enable and disable connection of the endoscope 100 to a control apparatus 140, which includes the light source apparatus 120 and a processor 130.

Note that various channels such as a forceps channel, into which a treatment instrument for collecting tissue is inserted, and a channel for insufflation and water conveyance, which are not depicted, are provided within the operation portion 110 and the insertion portion 101.

The insertion portion 101 includes a flexible portion 102 with flexibility, a bending portion 103, and a distal end portion 104. An irradiation opening 105 configured to irradiate light onto the observed region, and the image pickup device 106, such as a CCD (charge coupled device) image sensor or a CMOS (complementary metal-oxide semiconductor) image sensor, configured to captures an image of the observed region and acquire image information are disposed on the distal end portion 104. A field lens unit 107 is disposed on a light receiving surface of the image pickup device 106.

The bending portion 103 is provided between the flexible portion 102 and the distal end portion 104, and is configured to be freely bendable by rotating an angle knob 111 disposed on the operation portion 110. The bending portion 103 can be bended in an arbitrary direction at an arbitrary angle according to an area of the subject or the like for which the endoscope 100 is used, and can aim an observation direction of the irradiation opening 105 and the image pickup device 106 on the distal end portion 104 toward a desired area to be observed. A cover glass and a lens, a depiction of which is omitted, are disposed over the irradiation opening 105 of the insertion portion 101.

The control apparatus 140 includes the light source apparatus 120, which generates illuminating light to be supplied to the irradiation opening 105 on the distal end portion 104 of the endoscope 100, and the processor 130, which performs image processing on an image signal from the image pickup device 106. The light source apparatus 120 is connected to the endoscope 100 via the connector 10A, which is an optical connector. The processor 130 is connected to the endoscope 100 via the connector 10C, which is an electrical connector.

A display section 150 configured to display image information and the like and an input section 160 configured to receive an inputted operation are connected to the processor 130. Based on an instruction from the operation portion 110 of the endoscope 100 or from the input section 160, the processor 130 performs image processing on an image pickup signal transmitted from the endoscope 100, generates a display image, and provides the display image to the display section 150.

The light source apparatus 120 includes a laser light source (LD) 121 as a light-emitting source, and light-emitting intensity of the laser light source (LD) 121 is controlled by a light source control section 122. The laser light source 121 is, for example, a laser diode that outputs blue laser light with a center wavelength of 445 nm. For the laser light source 121, a broad-area-type InGaN laser diode can be used, or alternatively, an InGaNAs laser diode or GaNAs laser diode can also be used.

Laser light outputted from the laser light source 121 is inputted to an optical fiber 125b by a condensing lens (not shown) and is transmitted to an optical fiber 125a via the connector 10B of the light source apparatus 120 and the connector 10A of the endoscope 100. Note that the above-described light source may be configured by using a light-emitting body such as a light-emitting diode.

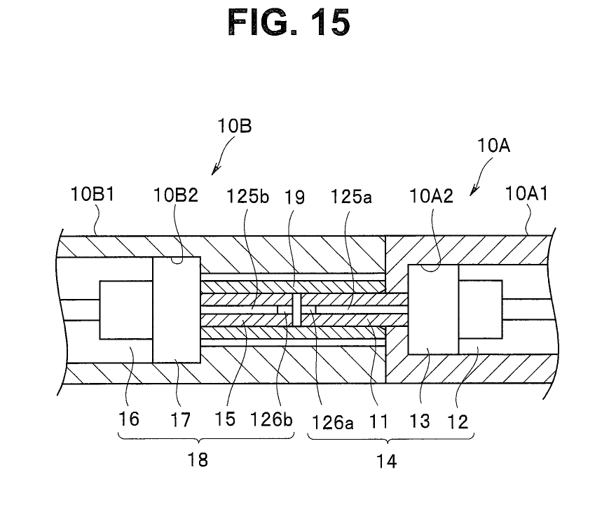

Here, the connector 10A of the endoscope 100, similarly to the optical connector 10, includes a ferrule 14, which includes a ferrule cylindrical body 11 configured to concentrically hold a proximal end side portion of the optical fiber 125a, and a flange 12 fitted on an end portion of the ferrule cylindrical body 11, as shown in FIG. 15.

The flange 12, similarly to the flange 50 of the optical connector 10, includes a flange portion 13 formed in a polygonal outer shape. The flange portion 13 is fitted into a polygonal attachment hole 10A2 formed in a housing body 10A1 of the connector 10A, and outer corner portions of the flange portion 13 come into contact with inner corner portions of the attachment hole 10A2, so as to prevent rotation of the ferrule 14 centered on an axis direction of the ferrule 14, whereby a rotation position is determined.

Similarly, the connector 10B of the light source apparatus 120 includes a ferrule 18, which includes a ferrule cylindrical body 15 configured to concentrically hold a proximal end side portion of the optical fiber 125b, and a flange 16 fitted on an end portion of the ferrule cylindrical body 15.

The flange 16, similarly to the flange 50 of the optical connector 10, includes a flange portion 17 formed in a polygonal outer shape. The flange portion 17 is fitted into a polygonal attachment hole 10B2 formed in a housing body 10B1 of the connector 10B, and outer corner portions of the flange portion 17 come into contact with inner corner portions of the attachment hole 10B2, so as to prevent rotation of the ferrule 18 centered on an axis direction of the ferrule 18, whereby a rotation position is determined.

The ferrule 14 of the connector 10A and the ferrule 18 of the connector 10B are coaxially held by a sleeve 19 with a C ring-shaped cross section, and are disposed in such a manner that a laser light exit surface and a laser light entrance surface are opposed to each other. In the present embodiment, the connectors 10A and 10B include optical transmission portions, respectively, where gradient-index (GRIN) lenses 126a and 126b are provided to an entrance end of the optical fiber 125a and an exit end of the optical fiber 125b, respectively, in an integral manner. The present embodiment uses a scheme in which optical coupling is performed by disposing the GRIN lenses 126a and 126b face-to-face in a non-contact manner.

That is, laser light transmitted through the optical fiber 125b is spread by the GRIN lens 126b of the connector 10B on the light source apparatus 120 side to become collimated light (beam), which is outputted from the exit end of the GRIN lens 126b. The collimated light (beam) outputted from the GRIN lens 126b is focused by the GRIN lens 126a of the connector 10A on the endoscope 100 side and inputted to an end face of the optical fiber 125a.

In this case, in the connectors 10A and 10B, an attachment position in a rotation direction of the flange portion 13 into the attachment hole 10A2 and an attachment position in a rotation direction of the flange portion 17 into the attachment hole 10B2 are adjusted so that optical axes of the GRIN lenses 126a and 126b are aligned with high accuracy. Accordingly, the laser light can be transmitted with high efficiency.

The laser light inputted to the optical fiber 125a is transmitted to the distal end portion 104 of the endoscope 100. A fluorescent substance 127, which is a wavelength conversion member, is disposed on the distal end portion 104, at a position opposing to a light exit end of the optical fiber 125a. The laser light from the laser light source 121 supplied from the optical fiber 125a excites the fluorescent substance 127 to emitting fluorescent light, and part of the laser light passes through the fluorescent substance 127.

The fluorescent substance 127 includes a plurality of types of fluorescent substances that are excited by absorbing part of energy of blue laser light to emitting green to yellow light. For a specific example of the fluorescent substance 127, a YAG fluorescent substance, or a fluorescent substance including BAM (BaMgAl₁₀O₁₇) and the like, can be used. Accordingly, as a result of mixing of the green to yellow excited light caused by the blue laser light as exciting light with the blue laser light that has passed through the fluorescent substance 127 without being absorbed, white (pseudo-white) illuminating light is outputted from the irradiation opening 105 on the distal end portion 104.

The white illuminating light made of the blue laser light and the excited and emitted light from the fluorescent substance 127 is irradiated from the distal end portion 104 of the endoscope 100 toward the observed region of the subject. Then, the field lens unit 107 forms, on a light receiving surface of the image pickup device 106, an image of a state of the observed region irradiated by the illuminating light, then the image is picked up. A picked-up image signal outputted from the image pickup device 106 after the image pickup device 106 picks up the image is transmitted to an A/D converter 129 through a cable 128 and converted into a digital signal, which is then inputted to the processor 130 via the connector 10C.

The processor 130 includes a control section 131 configured to control the light source apparatus 120, an image processing section 132 connected to the control section 131, and a correction information storage section 133. The correction information storage section 133 stores information such as a chromaticity correction table (color correction information) required for correction processing for adjusting the picked-up image signal to accurate chromaticities.

The picked-up image signal outputted from the A/D converter 129 is inputted to the image processing section 132. The image processing section 132 adjusts a white balance of the digital image signal outputted from the A/D converter 129 and performs gamma correction on resultant image data subjected to the white balance adjustment. Further, for the image data subjected to the gamma correction, respective image signals for R (red), G (green), and B (blue) are generated, and correction processing is performed on each of the image signals for R, G, and B so that an image with accurate chromaticities can be obtained. The image signals subjected to the color correction processing are converted into a color video signal including a luminance signal (Y) and a color-difference signal (Cb, Cr).

The converted color video signal is outputted from the image processing section 132 as a video signal, which is inputted to the control section 131. The video signal, along with various types of information, is converted into an endoscope observation image by the control section 131. The endoscope observation image is displayed on the display section 150 and, if necessary, is stored in a storage section including a memory and a storage device.

In the endoscope 100 as described above, the ferrule rotation positioning structure similar to the positioning structure of the optical connector 10 is also used for the connector 10A (10B) configured to make connection to the light source apparatus 120. Accordingly, when the connector 10B of the light source apparatus 120 and the connector 10A of the endoscope 100 are connected and laser light is transmitted, highly accurate adjustment relative to optical axis eccentricity can be made in a non-contact optical coupling scheme using the GRIN lenses 126a and 126b, and thus connection efficiency of the connectors can be ensured.

What is claimed is:

1. An optical connector comprising:
a ferrule configured to hold an optical transmitter that transmits light at a central axis of the ferrule, and including a flange portion formed as an n-sided regular polygonal columnar shape; and
a housing having a 2n-sided regular polygonal attachment hole which configured to attach the flange portion of the ferrule to the housing,
wherein the attachment hole comprising:
a first rotation restriction portion configured to restrict rotation of the flange portion against a direction of the central axis of the ferrule by contact n-corners of the 2n-sided regular polygon of the attachment hole with an outer corner of the n-sided regular polygon of the flange portion, when the ferrule is attached to the housing at a first rotation angle on the direction of the central axis; and
a second rotation restriction portion configured to restrict the rotation of the ferrule against the direction of the central axis of the ferrule by contact an n-corners of the attachment hole differed from the n-corners of the 2n-sided regular polygon of the attachment hole with the outer corner of the n-sided regular polygon of the flange portion, when the ferrule is attached to the housing at a second rotation angle that is different from the first rotation angle.

2. The optical connector according to claim 1,
wherein a shape of the first rotation restriction portion or a shape of the second rotation restriction portion is approximately equal to a shape of the outer corner portions of the n-sided regular polygon of the flange portion.

3. The optical connector according to claim 1,
wherein the flange portion is a four-sided regular polygon, and
wherein the attachment hole is an eight-sided regular polygon.

4. The optical connector according to claim 1,
wherein corners the outer shape of the flange portion are rounded.

5. The optical connector according to claim 1,
wherein corners of the flange portion are chamfered.
